(19) United States
(12) Patent Application Publication
(10) Pub. No.: US 2009/0206685 A1
(43) Pub. Date: Aug. 20, 2009

(54) MOTOR DEVICE

(75) Inventor: Hiroyuki Sonohara, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/368,107

(22) Filed: Feb. 9, 2009

(30) Foreign Application Priority Data
Feb. 8, 2008 (JP) 2008-28345

(51) Int. Cl. H02K 37/24

(52) U.S. Cl. 310/49.01; 310/83

(57) ABSTRACT

A motor device may include a motor main body having a stator portion and a rotary shaft having a lead screw portion projecting from the stator portion. The motor frame may have a rotary shaft support portion supporting an end of the rotary shaft on an output side and a stator support portion opposed to the rotary shaft support portion and fixed to the stator portion. An engaging member is engaged with the lead screw portion and movable in an axial direction of the rotary shaft. The engaging member is provided with two opposing faces respectively opposed to the rotary shaft support portion and the stator support portion. Positioning sections are formed on both the rotary shaft support portion and the stator support portion or on the two opposing faces of the engaging member for determining an original position for the engaging member to move in the axial direction.

### CROSS REFERENCE TO RELATED APPLICATION

The present invention claims priority under 35 U.S.C. § 119 to Japanese Application No. 2008-28345 filed Feb. 8, 2008, the entire contents of which are incorporated herein by reference.

### FIELD OF THE INVENTION

The present invention relates to a motor device, and more specifically relates to a motor device in which, by rotating a rotary shaft having a lead screw, an engaging member engaged with the lead screw is moved back and forth in the axial direction of the rotary shaft.

### BACKGROUND OF THE INVENTION

Publicly known motor devices are constructed such that a rotary shaft having a lead screw is equipped and an engaging member (sometimes called a carriage) engaged with the rotary shaft can be moved back and forth in the axial direction of the rotary shaft (See Patent references 1 through 3). This kind of motor is, for example, mounted in optical head devices and used as a drive source for optical lenses, etc.

[Patent reference 1] Japanese Patent Application H10-271793 Publication

[Patent reference 2] Japanese Patent Application 2000-139057 Publication

[Patent reference 3] Japanese Patent Application 2006-125574 Publication

In such a motor device, however, at least the original position of a drive object (an engaging member) needs to be detected to precisely regulate the movement of the drive object such as an optical lens. For this reason, a sensor is needed for detecting the original position and it has been an obstacle to cost reduction of the motor device.

On the other hand, if the motor device is so configured that the movement of the drive object is regulated having the contact position between the engaging member and the motor frame by which the motor main body and the rotary shaft are supported as the original position, it is not necessary to provide a sensor, which in turn reduces cost of the motor device. However, in such a sensor-less motor device, the engaging member is pressed against the motor frame. In other words, the engaging member makes contact with the motor frame with a relatively large contact surface; therefore, the movement of the engaging member may encounter resistance and be halted.

### SUMMARY

In view of the problems described above, at least an embodiment of the present invention may provide a motor device which requires no sensor to detect the original position of the engaging member and which minimizes resistance caused by surface-contact of the engaging member with respect to the motor frame, thus eliminating a common problem which usually prevents the movement of the engaging member.

In order to solve the problems described above, at least an embodiment of the present invention provides as follows:

A motor device according to at least an embodiment of the present invention comprises a motor main body having a stator portion and a rotary shaft which is provided with a lead screw portion projecting from the stator portion, a motor frame having a rotary shaft support portion and a stator support portion, the rotary shaft support portion supporting an end of the rotary shaft on the output side and the stator support portion being opposed to the rotary shaft support portion and fixed to the stator portion, and an engaging member which is engaged with the lead screw portion and attached movable back and forth in the axial direction of the rotary shaft; wherein the engaging member is provided with two opposing faces that are [respectively] opposed to the rotary shaft support portion and the stator support portion, and positioning sections are formed either on both the rotary shaft support portion and the stator support portion or on the two opposing surfaces of the engaging member for determining the original position for the engaging member to move in the axial direction.

According to at least an embodiment of the motor device of the present invention, positioning sections for determining the original position of the engaging member are formed either on both the stator support portion and the rotary shaft support portion formed to the motor frame or on the two opposing faces of the engaging member that are opposed to the stator support portion and the rotary shaft support portion; when the engaging member is moved to the front end or the rear end, the engaging member makes contact with the stator support portion or the rotary shaft support portion via the positioning section; therefore, the original position of the engaging member can be easily detected. In this case, there is no need to provide a sensor for detecting the original position in a machine in which the motor device is installed; therefore, the manufacturing cost of the motor device can be reduced greatly.

At that time, it is preferred that the positioning sections be projected in the axial direction and contact faces smaller than the opposing faces be formed at the ends of the positioning sections.

This configuration minimizes the contact area between the engaging member and either the stator support portion or the rotary shaft support portion when determining the original position of the engaging member. Therefore, even when the engaging member is pressed against the stator support portion or the rotary shaft support portion by the rotation power of the motor, the engaging member will not make [full] surface-contact with respect to the stator support portion or the rotary shaft support portion.

Further, in this case, it is preferred that the projection length of the positioning section be such that the rotary shaft support portion and the stator support portion may make only partial contact with the opposing faces but do not make full contact.

When the projection length of the positioning section is configured in this manner, the engaging member is prevented from making [full] surface-contact with the stator support portion or the rotary shaft support portion, [minimizing resistance and] resulting in smooth back-and-forth movements of the engaging member.

Also, it is preferred that a bearing be fixed to the rotary shaft support portion for supporting the shaft end of the rotary shaft and the projection length of the positioning section formed on the rotary shaft support portion or on the opposing face [of the engaging member] which is opposed to the rotary shaft support portion be longer than the projection length of the bearing which is projected from the rotary shaft support portion.

This configuration not only reduces the overall length of the motor device, which is [normally greater because of] the bearing projecting from the rotary shaft support portion toward the output side, but also, even when the bearing is fixed so as to be projected toward the side opposite the output side, minimizes resistance caused by surface contact between the engaging member and the bearing, thus eliminating a common problem which usually prevents the movement of the engaging member, which is caused when the engaging member is pressed against the bearing; thus, the engaging member can be smoothly moved back and forth.

It is preferred that either the motor frame or the engaging member be formed of resin.

When either the motor frame or the engaging member, which makes contact with each other for determining the original position of the engaging member, is formed of resin, resistance caused by contact between the motor frame and the engaging member can be minimized, compared to the configuration in which both members are formed of the same kind of material.

Also, it is preferred that the motor frame be formed of metal and the positioning sections be formed such that the ends of the rotary shaft support portion and the stator support portion are bent in the axial direction or plastically deformed.

With this configuration, the positioning sections can be formed simultaneously when the motor frame is formed by pressing; therefore, the cost of forming the positioning sections can be reduced.

Further, it is preferred that the positioning section formed on the rotary shaft support portion be formed by bending the end of the rotary shaft support portion and that a slit section be formed in the periphery of the positioning section.

When the slit section is provided in the above manner, the bending margin of the stator support portion or the rotary shaft support portion on which the positioning section is formed becomes smaller; therefore, bending by pressing is easier. Also, the machining precision of the positioning section can be greatly improved.

Furthermore, it is preferred that the positioning section formed on the stator support portion be plastically deformed having the end of the stator support portion directed toward the output side.

Also, it is preferred that the motor main body be a stepping motor.

With this, the movement of the engaging member can be freely regulated by controlling the number of steps of the stepping motor as long as the original position of the engaging member is determined by the above-described methods.

### EFFECTS OF THE INVENTION

According to at least an embodiment of the motor device of the present invention, the positioning sections for determining the original position of the engaging member are formed either on the stator support portion and the rotary shaft support portion of the motor frame or on the two opposing faces of the engaging member that are opposed to the stator support portion and the rotary shaft support portion; when the engaging member is moved to the front end or the rear end, the engaging member makes contact with the stator support portion or the rotary shaft support portion via the positioning section; therefore, the original position of the engaging member can be easily detected.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows explanatory diagrams of the configuration of a motor device of the first embodiment of the present invention: FIG. 1 (a) is a side view of the motor device on the output side in the short side direction; FIG. 1 (b) is a (partially cross-sectional) side view of the motor device in the longitudinal direction.

FIG. 2 shows an enlarged view of a motor main body of the motor device shown in FIG. 1.

FIG. 3 shows a perspective external view of an engaging member of the motor device shown in FIG. 1.

FIG. 4 shows a side view and a cross-sectional view of the engaging member of the motor device shown in FIG. 1 when the engaging member is moved all the way to the output-side (FIG. 4 (a)) and all the way to the opposite-side (FIG. 4 (b)).

FIG. 5 shows explanatory diagrams of the configuration of a motor device of the second embodiment of the present invention: FIG. 5 (a) is a side view of the motor device on the output-side in the short side direction; FIG. 2 (b) is a (partially cross-sectional) side view of the motor device in the longitudinal direction.

FIG. 6 shows a side view and a cross-sectional view of the engaging member of the motor device shown in FIG. 5 when the engaging member is moved all the way to the output-side (FIG. 6 (a)) and all the way to the opposite-side (FIG. 6 (b)).

### DETAILED DESCRIPTION

Embodiments of a motor device of the present invention will be described in detail hereinafter, referring to the drawings.

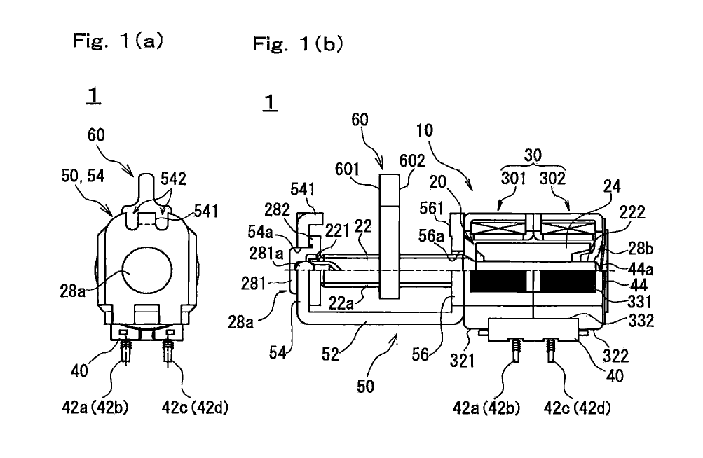

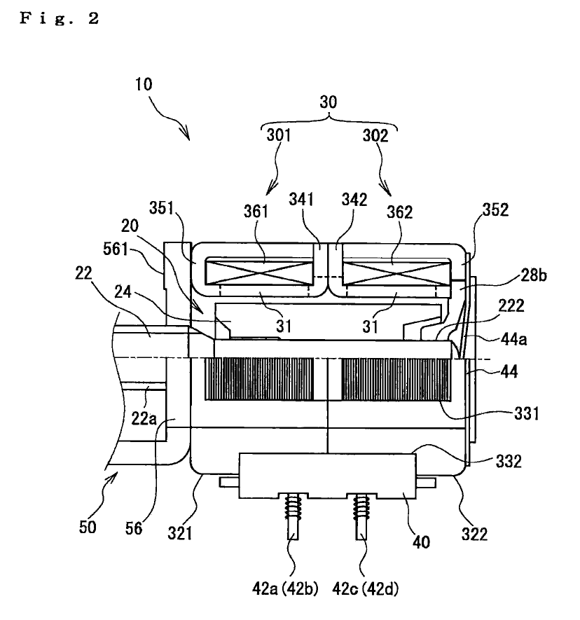

FIG. 1 and FIG. 2 are explanatory diagrams of the configuration of a motor device 1 of the first embodiment. FIG. 1 (a) is a side view of the motor device 1 on the output-side in the short side direction; FIG. 1 (b) is a (partially cross-sectional) side view of the motor device 1 in the longitudinal direction. Also, FIG. 2 is an enlarged view of a motor main body 10 of FIG. 1 (b).

The motor device 1 of this embodiment comprises a motor main body 10 having a rotary shaft 22 and a stator portion 30, a motor frame 50 having a rotary shaft support portion 54, by which an end of the rotary shaft 22 on the output side is supported, and a stator support portion 56 arranged to be opposite from the rotary shaft support portion 54 and fixed to the stator portion 30, and an engaging member 60 engaged with the rotary shaft 22.

The motor main body 10 is a so-called stepping motor equipped with the rotary shaft 22 and the stator portion 30. The rotary shaft 22 is arranged to project from the stator portion 30; on the side [of the rotary shaft 22] opposite the output side a permanent magnet 24 alternately magnetized with N-pole and S-pole in the circumferential direction is fixed by an adhesive to configure a rotor 20. Also, a lead screw 22a is formed on the outer side face of the rotary shaft 2 projecting from the stator portion 30 (note that the shaft end 221 on the output side is excluded). The rotary shaft 22 configured in this manner is supported such that the output-side bearing 28a thereof supported by the motor frame 50 (that is the bearing of at least an embodiment of the present invention) supports the output-side shaft end 221 and the opposite-side bearing 28b fixed to an outside stator core 352 supports the opposite-side shaft end 222.

The stator portion 30 is configured by a first stator assembly 301 and a second stator assembly 302 which are overlaid in the axial direction of the rotary shaft 22 at the position in the circumference opposing the permanent magnet 24.

As shown in FIG. 2, the first stator assembly 301 and the second stator assembly 302 are configured by inside stator cores 341 and 342, outside stator cores 351 and 352 and drive coils 361 and 362 which are sandwiched between the stator cores. Note that, in this embodiment, the drive coils 361 and 362 are so-called bobbin-less coils, which do not use a bobbin.

The inside stator cores 341 and 342 and the outside stator cores 351 and 352 respectively have a plurality of pole teeth 31 formed upright in the axial direction at an equal distance around the inside circumferential edge thereof. A plurality of pole teeth 31 which are formed so that [the teeth on] the inside stator core 341 and [the teeth on] the outside stator core 351 are alternately meshed on the inner circumferential side of the drive coil 361, 362. Therefore, in this embodiment, an annular drive coil 361 is positioned around the outer side face of the pole teeth 31 at the inside stator core 341 and the outside stator core 351 of the first stator assembly 301. In the same manner, an annular drive coil 362 is positioned around the outside circumference of the pole teeth 31 at the inside stator core 342 and the outside stator core 352 of the second stator assembly 302. Note that a thin insulation film (not illustrated) coats the entire surface of the drive coils 361 and 362 of this embodiment. For this reason, even the configuration without a coil bobbin will not cause short. Note that, although the drive coils 361 and 362 are arranged around the pole teeth 31, it is suitable that they be separated or an insulation member be interposed between them in order to prevent a short which is [normally] caused by direct contact between the outside surface of the pole teeth 31 and the inside circumferential surface of the drive coils 361 and 362.

The outside peripheral edge of the outside stator core 351, 352 is bent and formed upright to cover the outside circumference of the drive coil 361, 362 so that [the stator core 351, 352] respectively functions as a motor case. Hereinafter, the section of the outside stator core 351, 352 covering the drive coil 361, 362 is called first motor case 321 or second motor case 322. The first motor case 321 and the second motor case 322 are formed cylindrical by drawing.

In the side walls of both the first motor case 321 and second motor case 322, a first opening section 331 of a predetermined dimension is notched, and the motor device 1 of this embodiment is manufactured in a so-called oval-like shape. As understood from FIG. 1 and FIG. 2, the drive coils 361 and 362 are exposed from the first opening section 331. Also, a second opening section 332 of a predetermined dimension is notched at a location (the wall at the bottom in FIG. 1 (a) and FIG. 2) in the first motor case 321 and the second motor case 322, which is different from the first opening section 331. A terminal stand 40 projects from the second opening section 332 and is secured.

The terminal stand 40 is fixed to the outside peripheral edge of the inside stator core 341, 342, and has terminal pins 42a through 42d for power supply. This terminal stand 40 is fixed to the outside peripheral edge of the inside stator core 341, 342 by insert molding or press-fitting. Wire ends of the drive coils 361 and 362 are connected with the terminal pins 42a through 42d.

To the outside stator core 352, an opposite-side bearing 28b (radial bearing) for supporting the opposite-side shaft end 222 of the rotary shaft 22 is mounted by a means such as press-fitting. Further, to the outside stator core 352, an urging member 44 is fixed by laser soldering. The urging member 44 is provided with an urging portion 44a (flat spring) by which the rotary shaft 22 is urged to the output side. Also, the urging member 44 functions as a preventing section for the opposite-side bearing 28b from coming off.

The motor frame 50 is a substantially-U-shaped member which both ends of a metallic plate are bent at right angle, and is configured by a bottom plate portion 52, the rotary shaft support portion 54 and the stator support portion 56.

The bottom plate portion 52 is the base of the motor frame 50 and positioned parallel to the rotary shaft 22. The length [of the bottom plate portion] in the longitudinal direction is equal to the length of the lead screw formed on the rotary shaft 22, i.e., equal to the stroke amount of the engaging member 60. Also, the length [of the bottom plate portion] in the short side direction is longer than that of the engaging member 60 in the short side direction, which will be described later, and shorter than that of the motor case (the first motor case 321, the second motor case 322) in the short side direction.

The rotary shaft support portion 54 is a portion formed perpendicularly at the output-side edge of the bottom plate portion 52. In the center of the rotary shaft support portion 54, a bearing mounting hole 54a is formed to which the output-side bearing 28a supporting the output-side shaft end 221 of the rotary shaft 22 is fixed. More specifically described, the output-side bearing 28a is a pivot bearing which is configured by a main body portion 281 and a flange portion 282. In the center of the main body portion 281 a recess portion is created, into which a steel ball 281a is fitted, the steel ball 281a supporting the output-side shaft end 221 of the rotary shaft 22 urged toward the output side by the urging member 44. As apparent from FIG. 1, the output-side bearing 28a is fixed while the flange portion 282 is projected from the rotary shaft support portion 54 toward the side opposite the output side, so that overall length of the motor device 1 is minimized.

The stator support portion 56 is a portion formed perpendicularly at the opposite-side edge of the bottom plate portion 52 and positioned to be opposite from the rotary shaft support portion 54. In its center, a through hole 56a larger than the rotary shaft 22 is formed. The motor frame 50 is mounted such that the rotary shaft 22 passes through the through hole 56a and the stator support portion 56 is fixed to the first motor case 321 (the outside stator core 351) by laser soldering.

Note that the height of the rotary shaft support portion 54 and the stator support portion 56 is equal to that of the motor case (the first motor case 321, the second motor case 322). Also, the width dimension [of the rotary shaft support portion and the stator support portion] is equal to that of the bottom plate portion 52.

The motor device 1 of this embodiment has two positioning sections for determining the original position of the engaging member 60 which will be described later. More specifically described, the rotary shaft support portion 54 has an output-side positioning section 541 projected toward the side opposite the output side, and the stator support portion 56 has an opposite-side positioning section 561 projected toward the output side. The configuration and operation of the two positioning sections will be described later.

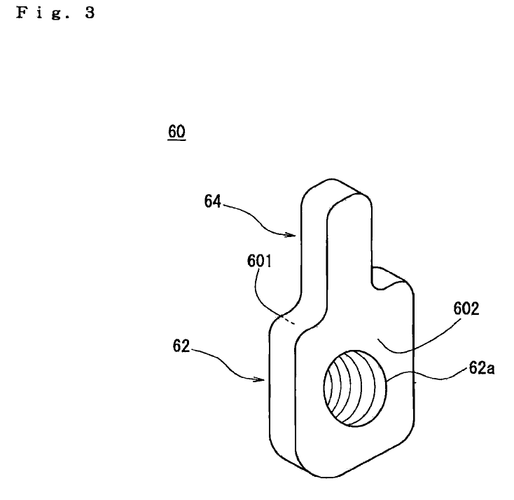

The engaging member 60 is formed of resin and is also called a carriage. FIG. 3 shows a perspective view of the external view of the engaging member 60.

The engaging member 60 is configured by a main body portion 62 and a connection portion 64 which is narrower than the main body portion 62. In the center of the main body portion 62 is formed an engaging hole 62a (formed as a nut) that can be engaged with the lead screw 22a of the rotary shaft 22. The connection portion 64 is connected to a drive object (an optical lens such as a collimating lens in an optical head device, for example) which is driven by the power of the motor device 1. In this embodiment, the connection portion 64 is connected by being adhered to a holder retaining a drive object; however, the configuration is not limited to this. For example, the connection portion 64 and (a holder retaining) a drive object may be connected to each other by screws.

As the lead screw 22a is engaged with the engaging hole 62a, the engaging member 60 is supported by the rotary shaft 22. Since the engaging member 60 itself is connected with a drive object, it will not rotate with the rotary shaft 22 in the rotation direction. Therefore, since the engaging member 60 moves back and forth in the axial direction of the rotary shaft 22 as the rotary shaft 22 is rotated, a drive object connected to the engaging member 60 also moves back and forth on a predetermined path parallel to the rotary shaft 22. Note that the motor device 1 of this embodiment is configured to have low torque so that, when the engaging member 60 makes contact with the positioning sections (the output-side positioning section 541 and the opposite-side positioning section 561), the rotation of the rotary shaft 22 is halted.

Note that, in the description hereinafter, the face of the engaging member 60 opposed to the rotary shaft support portion 54 is denoted as an output-side opposing face 601 and the face opposed to the stator support portion 56 is denoted as an opposite-side opposing face 602 (these output-side opposing face 601 and the opposite-side opposing face 602 are the opposing faces of at least an embodiment of the present invention.

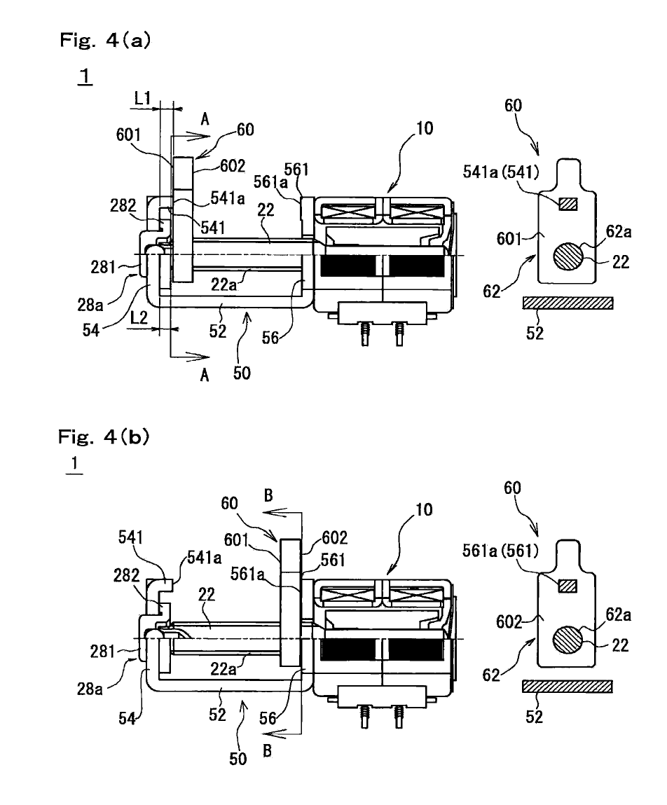

The motor device 1 configured as above is provided with the above-described output-side positioning section 541 and the opposite-side positioning section 561 to determine the original position of the engaging member 60. The configuration and the operation of the output-side positioning section 541 and the opposite-side positioning section 561 will be described hereinafter referring to FIG. 4. The diagram on the left side of FIG. 4 (a) shows the status [of the motor device] when the engaging member 60 is moved all the way to the output side. The diagram on the right side of FIG. 4 (a) is an A-A cross-sectional view of the output-side positioning section 541 crossed along the A-A line of the diagram on the left side of FIG. 4 (a). Also, the diagram on the left side of FIG. 4 (b) shows the status [of the motor device] when the engaging member 60 is moved all the way to the opposite side. The diagram on the right side of FIG. 4 (b) is a B-B cross-sectional view of the opposite-side positioning section 561 crossed along the B-B line of the diagram on the left side of FIG. 4 (b).

The output-side positioning section 541 is formed at the rotary shaft support portion 54. More specifically described, the end of the rotary shaft support portion 54 is bent in the axial direction to project toward the side opposite the output side. As shown in FIG. 4 (a), an output-side contact face 541a is formed on the end of the output-side positioning section 541. The output-side contact face 541a makes contact with the output-side opposing face 601 of the main body portion 62 of the engaging member 60 when the engaging member 60 is moved all the way to the output side. Since the output-side positioning section 541 is bent in the axial direction, the output-side contact face 541a is positioned parallel to the output-side opposing face 601. Also, the projection length, L1, of the output-side positioning section 541 at the rotary shaft support portion 54 in the direction opposite the output side is longer than the projection length, L2, of the flange portion 282 of the output-side bearing 28a; therefore, even when the engaging member 60 is moved all the way to the output side, the output-side opposing face 601 of the engaging member 60 will not make contact with the output-side bearing 28a.

Note that, as understood from FIG. 1 (a), a slit section 542 is formed around the periphery of the output-side positioning section 541. Such a slit section 542 is formed before pressing so that the bending margin for creating the output-side positioning section 541 becomes smaller; therefore, it is easy to fold the output-side positioning section 541 and as a result, the output-side positioning section 541 will not be bent too much or too little. Also, precision of the dimension of the projection length, L1, of the output-side positioning section can be greatly improved.

The opposite-side positioning section 561 is formed on the stator support portion 56. More specifically, the end of the stator support portion 56 is plastically deformed by half-blanking (press forming) [nidec-sankyo suggests: press half-blanking working] to be projected toward the output direction. Specifically, by half-blanking (press forming), the metal is extruded from the rear end of the stator support portion 56 (the end fixed to the first motor case 321) toward the front end (the opposite-side opposing face 602 of the engaging member 60) and a portion of the front end of the stator support portion 56 is plastically deformed to be projected toward the output direction. As shown in FIG. 4 (b), the end of the opposite-side contact face 561a makes contact with the opposite-side opposing face 602 of the main body portion 62 of the engaging member 60 when the engaging member 60 is moved all the way to the opposite side. With this, even when the engaging member 60 is moved all the way to the opposite side, the opposite-side opposing face 602 of the engaging member 60 will not make full contact with the stator support portion 56.

In this manner, the motor device 1 of this embodiment is configured such that the engaging member 60 makes contact with the positioning section (the output-side positioning section 541 or the opposite-side positioning section 561) when the engaging member 60 is moved all the way to the output side or to the opposite site. Therefore, the rotation amount of the motor main body 10 is regulated having the contact position between the engaging member 60 and the positioning section as the original position to precisely control the moving amount of the engaging member 60. Consequently, there is no need to mount a sensor for detecting the original position of the engaging member 60 in the motor device 1 or in a machine in which the motor device 1 is installed, resulting in reduced cost of the motor device 1 or the machine in which the motor device 1 is installed.

As understood from the A-A cross-sectional view of FIG. 4 (a), the output-side contact face 541a of the output-side positioning section 541 is formed smaller in dimension than the output-side opposing face 601 of the main body portion 62 of the engaging member 60. As understood from the B-B cross-sectional view of FIG. 4 (b), the opposite-side contact face 561a of the opposite-side positioning section 561 is also formed smaller in dimension than the opposite-side opposing face 602 of the main body portion 62 of the engaging member 60. Therefore, in the motor device 1 of this embodiment, the opposing face of the engaging member 60 will not make full contact with the stator support portion 56 when the engaging member 60 is moved all the way to the output-side or to the opposite side; as a result, this minimizes resistance caused by surface contact of the engaging member 60 with respect to the rotary shaft support portion 54 or the stator support portion 56, thus eliminating a common problem which usually prevents the movement [of the engaging member 60], and the engaging member 60 (a drive object) can be operated back and forth smoothly.

Further, as described above, the projection length, L1, of the output-side positioning section 541 at the rotary shaft support portion 54 in the direction opposite the output side is formed longer than the projection length, L2, of the flange portion 282 of the output-side bearing 28a; therefore, [even] when the engaging member 60 is moved all the way to the output side, the output-side opposing face 601 of the engaging member 60 will not make contact with the output-side bearing 28a which is projected from the opposite-side to minimize the overall length of the motor device 1. Therefore, the dimension of the overall length of the motor device 1 can be reduced and resistance caused by surface contact between the engaging member 60 and the output-side bearing 28a can be minimized, thus eliminating a common problem which usually prevents the movement of the engaging member 60.

Note that the projection length of the opposite-side positioning section 561 at the stator support portion 56 in the output direction can be of any length as long as the opposite-side opposing face 602 of the engaging member 60 will not make full contact with the stator support portion 56. In other words, the projection length does not need to be longer than necessary (if the projection length is set long while the stroke volume of the engaging member 60 is maintained the same, the motor device 1 will be larger); therefore, considering workability, the stator support portion 56 is plastically deformed by half-blanking (press forming).

For this reason, if the configuration is not that the flange portion 282 of the output-side bearing 28a is fixed while projecting from the rotary shaft support portion 54 in the direction opposite the output side, the projection length, L1, of the output-side positioning section 541 in the direction opposite the output side does not need to be longer than necessary. Therefore, in this case, it is preferred that the output-side positioning section 541 be formed by half-blanking (press forming) in the same manner as the opposite-side positioning section 561.

As shown by the A-A cross-sectional view of FIG. 4 (a) and the B-B cross-sectional view of FIG. 4 (b), it is preferred that the output-side positioning section 541 and the opposite-side positioning section 561 be arranged above the axial line of the rotary shaft 22. With this configuration, the engaging member 60 makes contact with the output-side positioning section 541 and the opposite-side positioning section 561 at the center position between the connection portion 64 which is engaged with the drive object and the engaging hole 62a which is engaged with the rotary shaft 22; therefore, the inclination of the engaging member 60 can be controlled when it makes contact with each of the positioning sections, compared to the configuration in which the output-side positioning section 541 and the opposite-side positioning section 561 are arranged below the axial line of the rotary shaft 22.

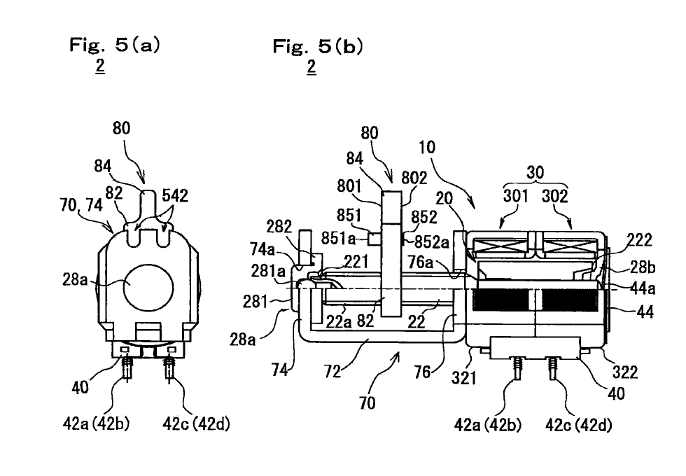

Next, a motor device 2 of the second embodiment of the present invention will be described. FIG. 5 is an external view of the motor device 2: FIG. 5 (a) is a side view of the motor device 2 on the output side in the short side direction and FIG. 5 (b) is a (partially cross-sectional) side view of the motor device 2 in the longitudinal direction. Note that the same codes are given to the portions of the configuration that are the same as those of the motor device 1 of the first embodiment and their description is omitted, but [the portions of] the configuration which are different [from the first embodiment] are mainly described.

The motor device 2 of this embodiment comprises a motor main body 10, a motor frame 70 and an engaging member 80. Among those, the configuration of the motor main body 10 is the same as that of the motor device 1 of the above-described embodiment.

The motor frame 70 is configured by a bottom plate portion 72, a rotary shaft support portion 74, and a stator support portion 76. While the general shape [of the motor frame 70] is the same as that of the motor device 1 of the first embodiment, it is different from the motor device 1 in that the positioning sections (the output-side positioning section 541 and the opposite-side positioning section 561) are not arranged on the rotary shaft support portion 74 and the stator support portion 76.

The engaging member 80 has a main body portion 82 and a connection portion 84, and those configurations are the same as those of the motor device 1 of the first embodiment. However, this embodiment is different from the motor device 1 in that the positioning sections are arranged on the opposing faces of the engaging member 80. In other words, an output-side positioning section 851 is formed on the output-side opposing face 801 of the main body portion 82 of the engaging member 80, and it projects toward the output side and can make contact with the rotary shaft support portion 74. Also, an opposite-side positioning section 852 is formed on the opposite-side positioning section 802 of the main body portion 82 of the engaging member 80, and it projects in the direction opposite the output side and can make contact with the stator support portion 76. The output-side contact face 851a and the opposite-side contact face 852a are respectively formed at the end of the output-side positioning section 851 and the end of the opposite-side positioning section 852.

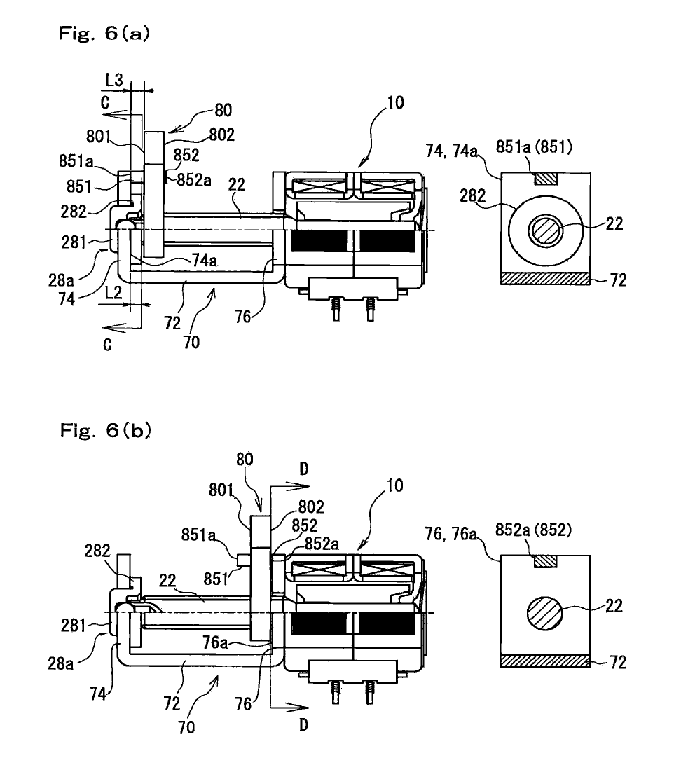

Next, the configuration and operation of the output-side positioning section 851 and the opposite-side positioning section 852 will be described hereinafter referring to FIG. 6. The diagram on the left side of FIG. 6 (a) shows the status when the engaging member 60 is moved all the way to the output side. The diagram on the right side of FIG. 6 (a) is an C-C cross-sectional view of the output-side positioning section 851 crossed along the C-C line of the diagram on the left side of FIG. 6 (a). Also, the diagram on the left side of FIG. 6 (b) shows the status when the engaging member 60 is moved all the way to the opposite side. The diagram on the right side of FIG. 6 (b) is a D-D cross-sectional view of the opposite-side positioning section 852 crossed along the D-D line in the diagram on the left side of FIG. 6 (b).

As understood from FIG. 6 (a), when the engaging member 80 is moved all the way to the output side, the output-side positioning section 851 of the engaging member 80 and the rotary shaft support portion 74 make contact with each other. Also, as understood from FIG. 6 (b), when the engaging member 80 is moved all the way to the opposite side, the opposite-side positioning section 852 and the stator support portion 76 make contact with each other. Therefore, according to the motor device 2 of this embodiment, the rotation of the motor main body 10 is regulated having the contact position between the positioning sections formed on the engaging member 80 [lit: 60] (the output-side positioning section 74 and the opposite positioning section 852) and the motor frame 70 (the rotary shaft support portion 74 and the stator support portion 76) as the original position so that the moving amount of the engaging member 80 can be precisely controlled. For this reason, it is not necessary to mount a sensor in the motor device 2 [lit: 1] or in a machine in which the motor device 2 [lit: 1] is installed to detect the original position of the engaging member 80. This reduces cost of the motor device 2 [lit: 1] or the machine in which the motor device 2 [lit: 1] is installed.

As understood from the C-C cross-sectional view of FIG. 6 (a), the output-side contact face 851a of the output-side positioning section 851 is formed smaller in dimension than the contact face 74a of the rotary shaft support portion 74. As understood from the D-D cross-sectional view of FIG. 6 (b), the opposite-side contact face 852a of the opposite-side positioning section 852 is also formed smaller in dimension than the contact face 76a of the stator support portion 76. Therefore, the opposing faces of the engaging member 80 [lit: 60] will not make full contact with the motor frame 70 when the engaging member 60 is moved all the way to the output-side or to the opposite side; as a result, this minimizes resistance caused by the surface contact of the engaging member 80 with respect to the rotary shaft support portion 74 or the stator support portion 76, thus eliminating a common problem which usually prevents the movement [of the engaging member], and the engaging member 80 (a drive object) can be operated back and forth smoothly.

Here, as understood from FIG. 6 (a), the projection length, L3, of the output-side positioning section 851 in the output direction is longer than L2, the projection length of the flange portion 282 of the output-side bearing 28a at the rotary shaft support portion 54. It is for the same reason as that [given above] when noting that the projection length, L1, of the output-side positioning section 541 is longer than L2 in the motor device 1 described in the first embodiment. In other words, when the engaging member 80 is moved all the way to the output side, this configuration minimizes resistance caused by the surface contact between the engaging member 80 and the output-side bearing 28a, thus eliminating a common problem which usually prevents the movement of the engaging member 80.

In this manner, according to the motor device 1 of the first embodiment, the positioning sections (the output-side positioning section 541 and the opposite-side positioning section 561) for determining the original position of the engaging member 60 are formed on both the rotary shaft support portion 54 and the stator support portion 56 of the motor frame 50. When the engaging member 60 is moved to the front end or the rear end, the rotary shaft support portion 54 or the stator support portion 56 makes contact with the engaging member 60 via the positioning section 541 or 561; therefore, the original position of the engaging member 60 can be easily detected. Also, in the motor device 2 of the second embodiment, the positioning sections (the output-side positioning section 851 and the opposite-side positioning section 852) in place of the output-side positioning section 541 and the opposite-side positioning section 561 are formed on the opposing faces (the output-side opposing face 801 and the opposite-side opposing face 802) of the engaging member 80. With this configuration, the rotary shaft support portion 74 and the stator support portion 76 make contact with the engaging member 80 via the positioning sections; therefore, the original position of the engaging member 80 can be easily detected in the same manner as the first embodiment.

Also, the output-side contact face 541a (851a) and the opposite-side contact face 561a (852a) are formed on the projection ends of the above-described positioning sections and they are respectively smaller than the output-side opposing face 601 (801) and the opposite-side opposing face 602 (802) of the engaging member 60 (80). For this reason, the engaging member 60 (80) makes contact with the rotary shaft support portion 54 (74) or the stator support portion 56 (76) over a smaller area in determining the original position of the engaging member 60 [(80)]. Therefore, even when the engaging member 60 (80) is pressed against the rotary shaft support portion 54 (74) or the stator support portion 56 (76) by the rotation power of the motor, there will be minimal resistance caused when the engaging member 60 (80) makes surface-contact with the rotary shaft support portion 54 (74) or the stator support portion 56 (76) and therefore, there will be no problem in the back-and-forth movement of the engaging member 60 (80). Consequently, the engaging member 60 (80) can be moved back and forth smoothly.

Further, the projection length of the positioning section is determined in such a way that the rotary shaft support portion 54 (74) and the stator support portion 56 (76) will not make full contact with the opposing faces of the engaging member 60 (80). This improves the effect of minimizing resistance caused by surface contact of the engaging member 60 (80) with respect to the rotary shaft support portion 54 (74) and the stator support portion 56 (76), thus eliminating a common problem which prevents the movement of the engaging member 60 (80).

The output-side bearing 28a is fixed to the rotary shaft support potion 54 (74) to support the output-side shaft end 221 of the rotary shaft 22; the projection length of the above-described positioning section is longer than the projection length of the output-side bearing 28a projecting from the rotary shaft support portion 54 (74). For this reason, according to these embodiments, resistance caused by surface contact between the engaging member 60 (80) and the output-side bearing 28a can be minimized and the problem which usually prevents the movement of the engaging member 60 (80) can be eliminated.

Also, since the motor frame 50 (70) is formed of metal and the engaging member 60 (80) is formed of resin, resistance created by the contact between the motor frame 50 (70) and the engaging member 60 (80) can be minimized, compared to the configuration that both components are formed of the same kind of material.

Also, in the first embodiment, the output-side positioning section 541 is formed such that the end of the rotary shaft support portion 54 is bent in the axial direction of the rotary shaft 22, and the opposite-side positioning section 561 is formed by plastically deforming the stator support portion 56 by half-blanking (press forming) [nidec-sankyo suggests: press half-blanking working]. Therefore, while the motor frame 50 is being formed by pressing, the positioning sections can be formed simultaneously. Thus, this prevents the increase of the machining cost which [conventionally] happens when forming the positioning sections.

Further, in the first embodiment, the output-side positioning section 541 is formed such that the end of the rotary shaft support portion 54 is bent in the axial direction of the rotary shaft 22, and the slit section 542 is formed in the periphery of the output-side positioning section 541. Because the slit section 542 is formed, the bending margin of the rotary shaft support portion 54 for forming the output-side positioning section 541 becomes smaller, facilitating bending by pressing. Also, machining precision of the output-side positioning section 541 can be greatly improved.

The embodiments of the present invention have been described in detail; however, the present invention is not limited to the above-described embodiments, but can be varyingly modified within the scope of the present invention.

For instance, the motor main body 10 is a stepping motor in the above-described embodiments; however, other motors such as a DC motor may be used.

Also, the motor frame 50 (70) is formed of metal and the engaging member 60 (80) is formed of resin in the above-described embodiments; however, they are not limited to this, but the motor frame 50 (70) may be formed of resin and the engaging member 60 (80) may be formed of metal, or both members may be formed of [the same material], resin or metal.

In the above-described embodiments, a positioning section (the output-side positioning section 541 (851) or the opposite-side positioning section 561 (852) is provided on the output-side or the opposite-side for determining the original position of the engaging member 60; however, two or more positioning sections may be provided respectively on the output-side and the opposite-side. Further, the two positioning sections are formed on the motor frame 50 (the rotary shaft support portion 54 and the stator support portion 56) in the first embodiment and to the engaging member 80 (the output-side opposing face 801 and the opposite-side opposing face 802) in the second embodiment; however, the configuration is not limited to this. In other words, one of the positioning sections may be provided to the motor frame 50 (the rotary shaft support portion 54 or the stator support portion 56) and the other positioning section may be provided to the engaging member 80 (the output-side opposing face 801 or the opposite-side opposing face 802).

The original position of the engaging member 60 in the first embodiment is determined as it makes contact with the output-side contact face 541a or the opposite-side contact face 561a, and the original position of the engaging member 80 in the second embodiment is determined as the output-side contact face 851a or the opposite-side contact face 852a thereof makes contact with the rotary shaft support portion 74 or the stator support portion 76; however, the positioning section is not limited to the configuration described above. For instance, the end of the positioning section may be formed spherical and the original position [of the engaging member] may be determined by a point contact.

Also, the output-side positioning section 541 of the first embodiment may be provided to the flange portion 282 of the output-side bearing 28a.

In the above-described embodiments, the engaging member 60 which is moved back and forth by the rotation of the rotary shaft 22 is engaged with the rotary shaft 22 through the engaging hole 62a bored in the engaging member 60 (engaged by a screw); however, it is not limited to this configuration. For instance, a guide shaft different from the rotary shaft 22 may be provided and the engaging member exerted by the rotation power of the rotary shaft 22 may be guided by the guide shaft and moved back and forth.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor device comprising:
a motor main body having a stator portion and a rotary shaft which has a lead screw portion projecting from the stator portion;
a motor frame having a rotary shaft support portion and a stator support portion, the rotary shaft support portion supporting an end of the rotary shaft on an output side and the stator support portion being opposed to the rotary shaft support portion and fixed to the stator portion;
and an engaging member which is engaged with the lead screw portion and attached movable back and forth in an axial direction of the rotary shaft;
wherein the engaging member is provided with two opposing faces which are respectively opposed to the rotary shaft support portion and the stator support portion; and positioning sections are formed either on both the rotary shaft support portion and the stator support portion or on the two opposing faces of the engaging member for determining an original position for the engaging member to move in the axial direction.

2. The motor device as set forth in claim 1 wherein the positioning sections are projected in the axial direction and contact faces smaller than the opposing faces are formed on ends of the positioning sections.

3. The motor device as set forth in claim 2 wherein a projection length of the positioning section is set to a dimension with which the rotary shaft support portion and the stator support portion may make partial contact with the opposing faces but do not make full contact.

4. The motor device as set forth in claim 2 wherein a bearing is fixed to the rotary shaft support portion to support a shaft end of the rotary shaft,
and the projection length of the positioning section formed on an opposing face opposed to the rotary shaft support portion or the rotary shaft support portion is longer than the projection length of the bearing projecting from the rotary shaft support portion.

5. The motor device as set forth in claim 1 wherein either the motor frame or the engaging member is formed of resin.

6. The motor device as set forth in claim 1 wherein the motor frame is formed of metal, and the positioning sections are formed such that ends of the rotary shaft support portion and the stator support portion are bent in the axial direction and plastically deformed.

7. The motor device as set forth in claim 6 wherein the positioning section formed on the rotary shaft support portion is formed such that the end of the rotary shaft support portion is bent in the axial direction, and a slit section is formed in a periphery of the positioning section.

8. The motor device as set forth in claim 6 wherein the positioning section formed on the stator support portion is formed by plastic deformation having an end of the stator support portion directed toward an output direction.

9. The motor device as set forth in claim 1 wherein the motor main body is a stepping motor.

10. The motor device as set forth in claim 3 wherein a bearing is fixed to the rotary shaft support portion to support a shaft end of the rotary shaft, and the projection length of the positioning section formed on an opposing face opposed to the rotary shaft support portion or the rotary shaft support portion is longer than the projection length of the bearing projecting from the rotary shaft support portion.
